(19) United States
(12) Patent Application Publication
(10) Pub. No.: US 2003/0145449 A1
(43) Pub. Date: Aug. 7, 2003

(54) Processing arrangement

(76) Inventor: Heinrich Lutz, Dirlewang (DE)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/326,146

(22) Filed: Dec. 23, 2002

(30) Foreign Application Priority Data
Dec. 21, 2001 (DE) 101 63 445.5

(51) Int. Cl. B23P 23/00

(52) U.S. Cl. 29/564; 29/33 P

(57) ABSTRACT

The invention deals with a machining installation comprising at least one transfer path which conveys a workpiece to several machining stations. In the machining stations at least one tool spindle is provided. The workpiece is moved while being machined by the tool spindles.

### BACKGROUND OF THE INVENTION

The invention relates to a machining installation with at least one transfer path feeding a workpiece to a plurality of machining stations, at least one tool spindle being provided in the machining stations and the workpiece being situated in the machining station during a machining period and undergoing machining along at least one axis by at least one tool spindle.

For that purpose it is known, for example, to clamp the workpieces on so called cars which convey the workpieces through the different machining stations. The car (or slide) is positioned and fixed exactly in the machining station also defining the exact position of the workpiece relatively to the reference positions precisely. Reversedly the tool spindle can be exactly positioned along the three space axes if the transfer line is supposed to be flexible (open for changes of the workpieces). The controlling means determines the suitable machining position with regard to the reference position. For the high mobility of the tool spindle along the space axes naturally an appropriate effort in the design of the tool spindle is necessary. Guides for compound slides have become known which allow a high mobility of the tool spindle, however, they are suitably expensive. As the guides for the compound slides are, for example, designed in an ortogonally nested way in particular for the first guide or axis a considerable effort results as the total weight of the two other guides and the tool spindle itself rests on it.

This leads to a large construction effort of the guide, respectively the positioning of the tool spindles, on the other hand powerful drives have to be provided in order to realise a machining, respectively positioning, of the tool spindles in a highly dynamic way. This also leads to an additional effort. Furthermore, this construction of a machining installation needs, according to the state of the art, comparatively much room.

In the above often an axis is mentioned the term axis being not only understood as rotation axis but generally describing a direction or space direction. In particular the “axis” has to be understood also as the single axis of a cartesian or orthogonal system where the different axis are arranged in particular in a rectangular way to each other and thus allowing a definition of a space point in three dimensions.

### BRIEF DESCRIPTION OF THE INVENTION

The object of the present invention is to develop machining installations, as mentioned above, where the large effort for the spindle is no more necessary for a comfortable and, if necessary, also complex machining of the workpiece.

In order to solve this task the invention comes from a machining installation as described above and suggests that the workpiece moves during at least part of the machining line.

The suggestion according to the invention provides a plurality of advantages. First of all it is possible to simplify the construction of the installation clearly because the necessary movements, respectively the axes, between workpiece and the machining spindles, respectively tool spindles, are distributed. As the construction effort for positioning the machining spindle is reduced also automatically the powers necessary for positioning, respectively acceleration, of the spindle decrease making it possible to provide drives with a smaller dimension at the same speed. The suggestion according to the invention makes it also possible to dispense with an automatic tool change on the machining spindles. In the known installations a tool change has been provided in order to use the comparatively high effort for tool spindles for a plurality of different tools. However, if the tool is changed during a chip removal machining it may happen that during the tool change dirt or chips will fall on the cone or the flange of the tool holding system and thus prevent a secure clamping of the workpiece. According to the idea of the invention simply another spindle is provided which can be realised with a considerably smaller effort and now fulfils the same function as a possible tool change in the known systems. This results in a clearly higher security of the process because possible sources for disturbances of the process are eliminated.

The invention proposes that the workpiece moves during at least part of the machining period. The machining period is determined by the time interval during which the workpiece is in the machining station. The concrete machining, that is, if necessary, mounting or the chip removal machining by means of the tool of the machining spindle does not matter alone. The suggestion according to the invention allows a certain mobility of the workpiece during the machining carrying out, in addition to the operation of the tool on the workpiece, naturally also appropriate new positions of the workpiece during the machining period.

In a further development of the invention it is proposed that the tool acts on the workpiece during the machining period, the workpiece thus being moved. By means of this further development according to the invention already one axis is eliminated which otherwise has to be provided during the motion of the machining spindle.

Alternatively it is furthermore provided according to the invention that the machining station has at least two tool spindles, and the workpiece is moved during the machining period from the first to the second tool spindle. In the same way also the advantage mentioned above is evident here. For positioning the tool at the tool spindle the motion of the workpiece is used and not the motion of the tool spindle. Of course it is possible here that during the machining period first a movement of the workpiece is carried out when the tool is in operation and then the workpiece is carried to the next tool spindle by the same conveying means, which has moved the workpiece during the machining through the tool.

It is advantageous that the clamping change between the machining motion (during the machining through the tool) and the transport motion to the next tool spindle can be left out making it possible to save time correspondingly.

Furthermore it is provided according to the invention that a conveying means serves to convey the workpiece between the machining stations and the conveying means also moves the workpiece during at least part of the machining period. Such an arrangement has a plurality of advantages. For moving the workpiece (transport, motion during machining of the workpiece, motion between two tool spindles in a machining station) one and the same conveying means is used. Additional, other conveying means can be dispensed with.

The simple concept results in the fact that the spindles can be constructed in a higher number of pieces more economically in larger series.

By means of the suggestion according to the invention it is possible that in multi-axes machining of the workpiece the different machining axes are distributed between the direction of movement of the tool spindle and the direction of movement of the workpiece. From that results the opportunity to design a plurality of axes, directions of movement, respectively machining directions of the machining installation in a highly dynamically way with very low effort. These are exactly the advantages of machining centers which can be applied flexibly. The machining installations according to the invention (for example in the previous construction of a normal transfer line) often are developed for complex machining processes and thus allow hardly variability in the use because of the very special orientation. The suggestion according to the invention, however, allows to provide flexibility in more complex machining installations as in a machining center. The suggestion according to the invention connects surprisingly the advantages of a flexibly working machining center with opportunities of a transfer line or other machining installations which are used in particular for complex machining procedures. The result is a machining installation where also smaller series can be realised economically and, simultaneously, allow a high flexibility in the conversion.

A particular advantage of the invention is the fact that the direction of motion of the workpiece, in particular during its machining, is parallel or approximately parallel to the direction of conveying of the workpiece. Additionally to the reduction of the effort for multi-axis machining, although a very complex opportunity for machining still remains, the invention makes use of another synergistic effect. In machining installations like transfer lines or sliding table machines already an axis of conveying is necessary. This conveying axis describes the motion of the workpiece between the different machining stations or tool spindles. This means that the workpiece is already being moved. Exactly this motion is now used in order to carry out the idea according to the invention. The workpiece is moved during the machining with the same means that takes over the conveying of the workpiece to the next machining station after the end of one machining step. Here the appropriate measures are taken in order to secure a highly exact machining along this axis of movement.

Furthermore it is provided that the workpiece rotates and/or moves in a plane mounted on a compound slide and/or moves rectangularly to the direction of conveying. For example it is provided that the workpiece can rotate around a horizontal or vertical axis. On the one hand this allows an appropriate turning during machining and also a turning in order to position it during a new machining step. The car guided for example in a standing or hanging way which conveys the workpiece has a corresponding pivot or drag bearing for an appropriate positioning of the workpiece. The suggestion according to the invention is not limited to a motion of the workpiece during a machining parallel to the direction of conveying. By means of suitable support of the workpiece different machining directions, respectively machining axes, are possible.

Here the workpiece is held, respectively machined, from above, from below and/or laterally. The machining installation allows very effective machining of the workpiece which allows a correspondingly optimal machining according to the way the workpiece is held.

It is provided that the workpiece is clamped on a car serving as a conveying means. The car moves on the transfer path. The workpiece is conveyed on the car through the machining installation the car moving also during machining of the workpiece. This design leads to the direct advantage of the idea according to the invention because the conveying axis is the same as the axis of movement, respectively is parallel to it. The arrangement of a workpiece on a car for conveying through a machining installation, like a transfer line, is sufficiently known, the constructive effort to carry out the suggestion according to the invention thus very low.

Alternatively, also according to the invention, it is suggested that a conveying unit is provided on the transfer path and comprises a positioning unit for holding the workpiece, the positioning unit and/or the conveying unit moving during the machining of the workpiece. Generally spoken naturally also the car carries out the task of the conveying unit, namely a conveying of the workpiece through the machining installation.

However, it is also possible to realise the idea according to the invention in another manner. In a variant according to the invention it is suggested that the workpiece is picked up from the transfer path by means of a conveying unit at the machining station and the conveying unit moves the workpiece also in the machining station. It is for example provided that the conveying unit is only provided for a movement in the machining station and it has to be considered that a plurality of spindles are arranged parallel next to each other or out-of-line at the machining station and, naturally, a conveying unit is provided in order to position the workpiece at the respectively desired machining spindle. Here it is possible that the conveying unit moves the workpiece also during the machining or this is carried out by an additional positioning unit. In this alternative the conveying unit does not carry out the conveying of the workpiece through the complete machining installation but, if necessary, only through one station. Another conveying means carries out this conveying.

Here it is suggested according to the invention that the car as well as the conveying unit comprise a positioning unit for holding the workpiece. For example it is provided that at the car not only the movement parallel to the direction of conveying for machining of a workpiece shall be derived. The workpiece is clamped on a positioning unit and the positioning unit, according to its design, allows further linear movements or rotations.

The invention suggests furthermore that a first conveying unit is provided to convey the workpiece through the machining installation and a transfer unit in the machining station transfers the workpiece from the first conveying unit to a second conveying unit and, after machining, back again. Through that an appropriate complex movement, respectively conveying, system can be realised. Comparatively simply designed first conveying units take over the conveying of the workpieces between the machining stations of a machining installation. In the machining stations second conveying units are arranged which, if necessary, are also equipped with positioning units or other means and support the machining of the workpiece adequately. These second conveying units may be designed more complex, it is an advantage if they are optimally adapted to the respective function of the machining station. For example the second conveying unit allows also a highly exact positioning, respectively movement, of the workpiece during the machining through the tool. In order to connect these two different conveying units a transfer unit is provided which transfers the workpiece appropriately between the two types of conveying units.

For example the machining installation according to the invention is in the form of a transfer line with a plurality of machining stations arranged one behind the other. It is typical that in a transfer line the direction of conveying of the workpieces is unidirectional, that is like a one way road. In the machining station one could, if necessary, deviate from that, that means in an appropriate position the workpiece can also be drawn back, however, as a rule there is no conveying back of the workpiece into a machining station situated before. The idea according to the invention, however, may be used also in a design described as sliding table machine where only few, for example two or three machining stations are connected by means of the sliding table. The sliding table is used here as a conveying unit or car in the sense of the invention the sliding table machine principally allowing a bi-directional machining that means that a workpiece introduced into the sliding table machine is also machined again accordingly after a backward movement from the first machining station.

The invention is not aimed only to a machining installation as described above but describes in the same way a transfer installation comprising a feed belt and a delivery belt for the workpieces and a robot which picks up the workpieces from the feed belt and transfers them to a transfer path of a machining installation. After machining the robot takes the workpiece from the transfer path and transfers it back to the delivery belt. The transfer installation, as described here, comprises for example several transfer paths, a U-shaped or closed-ring design of the transfer path allowing the work piece to be brought back again to the start of the transfer path at the end and there to be put out of the transfer path to the delivery belt by means of the robot, which in this way feeds and empties a plurality of transfer paths.

Feed and delivery belt must be seen here not only as simple conveyor belts but generally as conveying system for workpieces for industrial machining; for example pallet conveying systems aim at adequately intelligent rolls or conveying installations and so on.

The advantages of this variant according to the invention are that by means of the suggestion according to the invention a plurality of machining stations can be realised comparatively space-saving making it principally possible to arrange a larger number of machining stations in a small space and thus also to arrange transfer lines comparatively space-saving and by means of one robot to feed and empty a plurality of such transfer paths with workpieces. This advantage derives from the distribution of the axes of movement necessary for the machining of the workpieces between axes which are produced by the spindle and axes which are produced by the workpiece during the machining. By saving the necessary axes of movement at the spindles the invention allows a space-saving realisation of the spindles and thus also the realisation of a new type of installations of a transfer installation as described.

### BRIEF DESCRIPTION OF THE DIFFERENT FIGURES OF THE DRAWING

The invention is presented in the drawing schematically. In the drawings:

FIGS. 1, 4, 5, 6, 8 the machining installation according to the invention in a view in the direction of convey;

FIGS. 2, 3 two variants of the transfer installation according to the invention in a top view;

FIG. 7 a machining installation according to the invention designed as a sliding table machine in a top view;

FIG. 9 the machining installation according to the invention in a side view and

FIG. 10 the machining installation according to the invention in a three dimensional view.

### DETAILED DESCRIPTION OF THE PREFERRED EMBODIMENTS

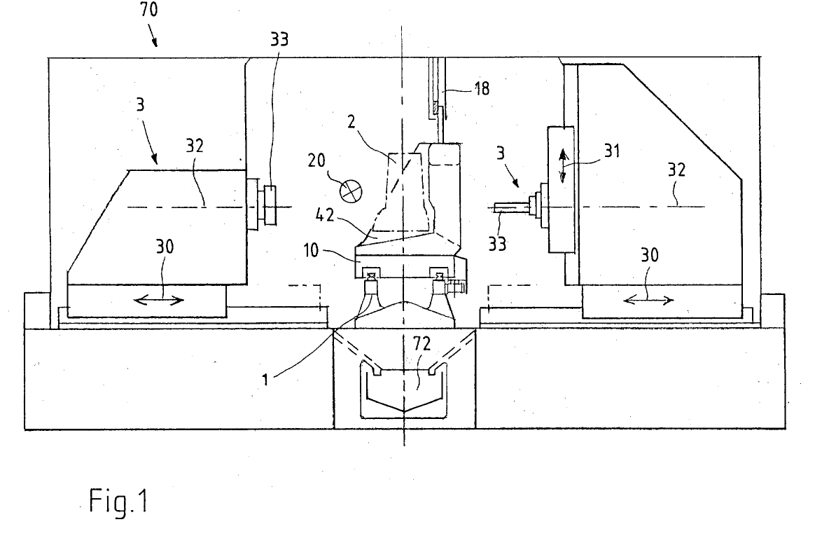

In FIG. 1 a machining installation 7 according to the invention is shown schematically. In the view presented here a machining station 70 can be seen. The workpiece 2 is clamped on a car 10.

At least one or a plurality of tool spindles 3 are provided in the machining station 70 on the left and right-hand side next to the workpiece 2. The axis of the tool spindles is marked with 32.

In the machining station 70 on the left hand and right hand side next to the workpiece 2 at least one or a plurality of tool spindles 3 are provided. The axis of the tool spindles is indicated with 32.

If necessary, the tool spindles 3 are combined in machining units which simultaneously hold a larger number of tool spindles 3. In FIG. 1 it is shown on the left hand side that the tool spindle (or the machining unit which in this case has the same effect) can be moved along an horizontal axis along the double arrow 30. This possibility of movement is perpendicular to the movement of the workpiece 2. A height adjustment of the position of the rotation axis 32 of the tool spindle is not provided here.

Such a vertical adjustment is provided in the right-hand side tool spindle 3 (respectively machining unit) where the guide of the tool spindle is also supported in a vertically movable slide which moves along the double arrow 31.

As machining tools 33 all known tools may be applied which are used for cutting machining. These comprise for example milling cutters, surface milling cutters, drills and so on.

As in the suggestion according to the invention the machining axes 30, 31 of the tool spindles 3 on the one hand and the movement of the workpiece 2 on the other hand (marked by the “X” in the circle 20) are distributed the constructive effort for realisation of the tool spindles 3 is reduced considerably. It is possible to carry the tool spindles on more simple consoles without reducing the flexibility or comfort of an adequate machining.

The third machining axis, respectively direction, is situated in the embodiment shown in FIG. 1 perpendicularly to the plane of drawing and is marked by the “X” in the circle 20.

In the base of the machine a rinsing channel 72 or a chip conveyor is carried. On the transfer path 1 a slide is carried movably on appropriate guide lines, the slide carries a clamping device 42 and is, for example, designed as a car.

The right-hand side spindle 3 is equipped with a horizontal slide (double arrow 31) and a vertical slide (double arrow 30). For each machining station several spindles arranged on the same side one behind the other may be provided.

The slide, respectively the car, is driven for example via a servomotor with pinion and steering rack at the transfer path. The slide, respectively the car 10, receives its energy through a busbar 18 which can be mounted above, at the side or below the transfer path 1. The servomotor together with transmitter and frequency converter is located in the car 10. Alternatively this slide may be also designed with a linear drive or with the technique of a maglev train.

By means of an appropriate design of the drive also a suitable highly exact positioning and motion of the car 10 during machining is possible. This can be achieved through suitable highly exact guides and drives which only have to be effective in the area of the machining in the machining station 70. All other slides, in particular the ones of the tool spindles 3, are driven by means of linear motors, with spherical roller spindles and servomotors, by means of a cylinder with servo hydraulic or servo pneumatic and so on. Because of the low effort for the realisation of the tool spindles it is also possible to realise highly dynamic that is fast moving slides for the tool spindles 3.

The suggestion according to FIG. 1 serves for the purpose that the motion of the workpiece on a car 10 serves, on the one hand, for conveying the workpiece through the machining installation and, on the other hand, simultaneously also as axis of movement 20 during an appropriate machining through a tool spindle 3.

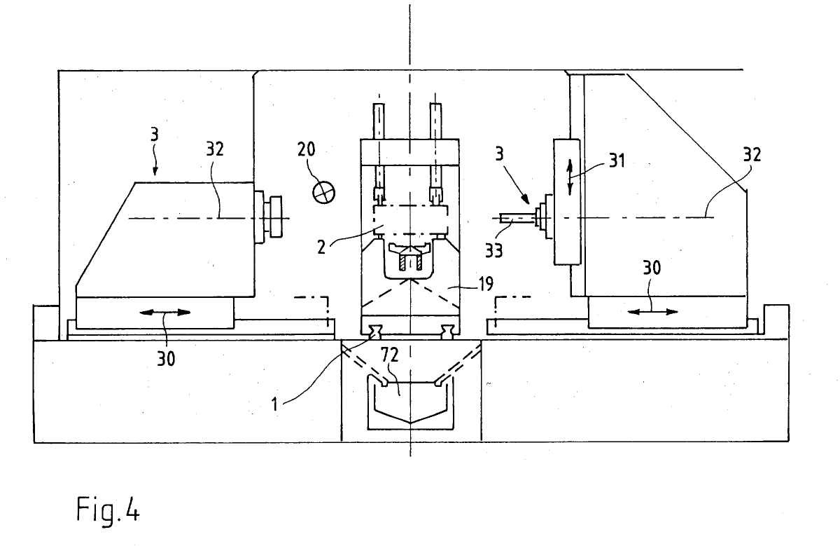

Instead of a car 10 in FIG. 4 a slide 19 is provided which is supported by the transfer path 1 and moves only in the area of the station and carries the clamping device. Thus, in each station the workpiece is clamped and declamped and clocked further over a stroke-step-transfer.

The suggestions according to FIGS. 1 and 4 have the purpose that the workpiece can be machined simultaneously from both sides. However, a constructive adjustment of the second machining head is necessary for that. If this dependence is to be avoided both machining heads have to be machining one after the other.

In the design with a car 10 testing devices can be mounted into the spaces between the machining stations 70 and the automatically driven cars 10 have to stop suitably positioned. If only the workpiece is conveyed by means of stroke-step-transfer into the next station between the machining stations 70 blank stations with testing devices can be integrated.

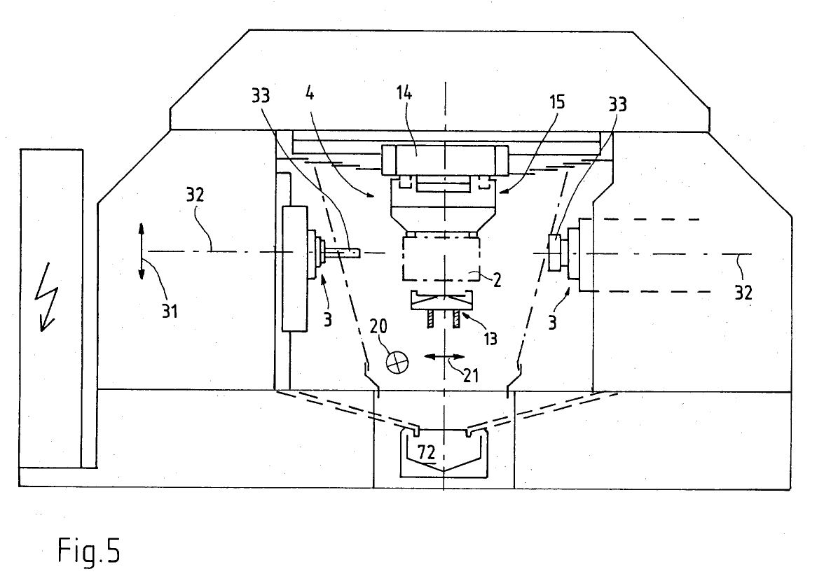

In FIG. 5 the solution according to the invention is comprised in another idea. The workpiece moves in the station in two directions and the left-hand side spindle moves only in a vertical direction 31. The right-hand side tool spindle 3 does not use a movable axis, it is stationary. The workpiece 2 is located between the two machining spindles 3. The machining tools 33 arranged on the tool spindles can in this example only be operated one after the other and are always independent from each other.

For example, the workpiece 2 is conveyed over a first conveying unit 13 into the machining station 70. Here the first conveying unit 13 supports the workpiece 2 from below. In the machining station the workpiece 2 is transferred to a second portal-like conveying unit 14 which is equipped with a compound slide guide 15.

By means of the design of the compound slide 15 the workpiece now has a second axis of movement which follows along the guides of the compound slide. These are indicated by the “X” in the circle 20 and with the double arrow 21. In this concept it is now possible to provide only one vertical movement 31 at the machining spindles 3 in order to allow a three sides, respectively a three axis, machining.

The compound slide guide 15 is located in a crosshead above the workpiece 2, respectively the spindles 3.

The embodiment of the second conveying unit 14 shown here corresponds also with the arrangement of a positioning unit 4 the positioning unit 4 being designed as a compound slide 15, but also may be only provided with a slide (in the direction of conveying) or a cross slide(rectangularly to the direction of conveying). Also a circular table can be arranged.

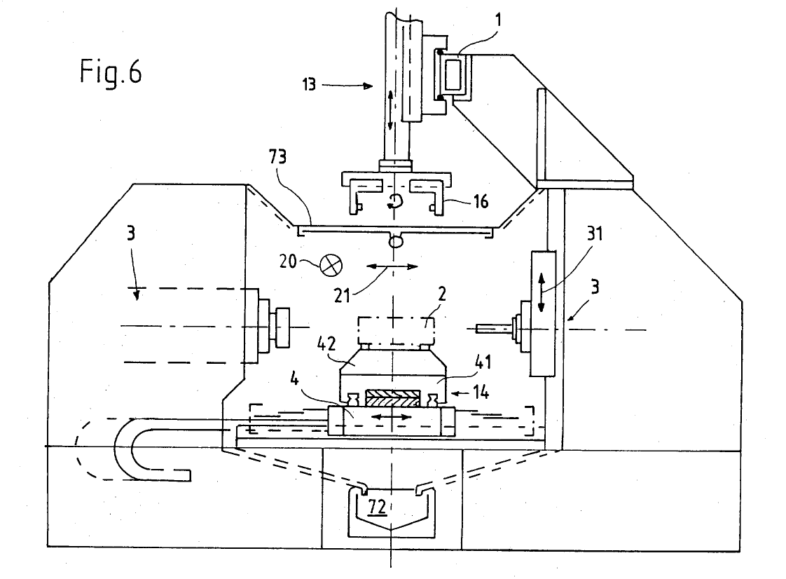

Similar to the suggestion according to FIG. 5 the suggestion according to FIG. 6 also concerns two conveying units. The workpiece is guided over the first conveying unit 13, which is supported movably on the transfer path 1, to the machining station and put over a door 73 from above in the station on the second conveying unit 14. This second conveying unit 14 is also designed as or equipped with a positioning unit 4. The positioning unit 4 carries a compound slide 41 and allows a positioning and/or movement of the workpiece 2 along two space axes 20, 21 which extend here horizontally. As vertical axis serves, for example, the right-hand side spindle 3 along the double arrow 31.

In the example described here the transfer path 1 is designed as a suspended rail. In the other examples, in particular in FIG. 1, it is designed as a rail line.

At the first conveying unit 13 a transfer device 16 is located which is designed as gripper which holds the workpiece and transfers it into the second conveying unit, respectively removes it from there after machining.

In the embodiment shown in FIG. 6 the workpiece 2 is carried and supported from below. It is possible to provide a circular table whose rotational axis is orientated vertically or horizontally and thus allows an additional possibility of positioning and/or machining. As the workpiece can be positioned and moved along several axes stationary consoles can be provided at the machining spindles, in particular for milling surfaces, in order to cushion the high forces during such machining securely. The transfer of the workpieces is carried out from above and, if necessary, the gripper 16 may be designed pivotally around a horizontal axis in order to transfer the workpiece optimally to the holding device. This may be equipped, for example, with a clamping device 42.

The concept according to the invention allows an arrangement of a higher number of machining spindles on the same surface. This does not reduce the flexibility, respectively the possibility, of application of such a machining installation, this makes it possible to reduce clearly the constructive effort and also the effort for the transport of such machining installations.

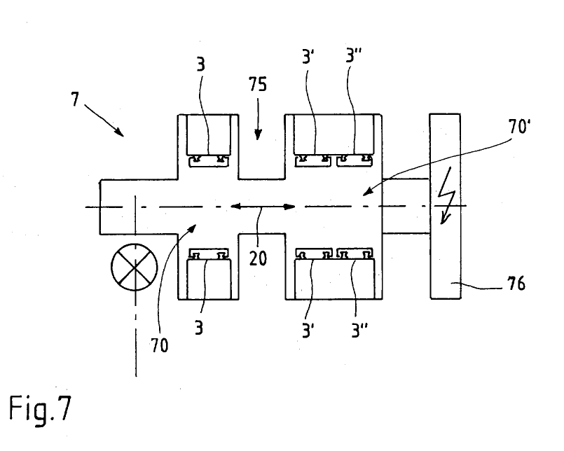

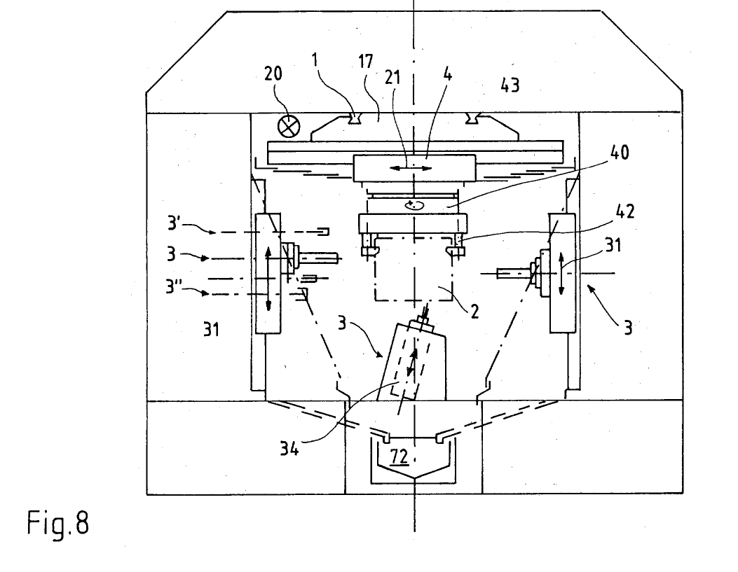

FIG. 7 shows an embodiment of the machining installation according to the invention in the shape of a sliding table machine 75. The design according to FIG. 7 corresponds with the view according to FIG. 8. The sliding table machine 75 is characterised in this example by only two machining stations 70. In the first one two, in the second one altogether four vertical slides with machining spindles 3, 3′, 3″ are provided. The sliding table 17 (not shown in FIG. 7) moves regularly between the two machining stations 70, 70′. Loading and unloading is carried out for example manually or automatically on the left hand side of the drawing. On the opposite side the electro box 76 is located.

In the embodiment shown in FIG. 8 the workpiece 2 is suspended from the sliding table 17 from below, however, naturally also a design the other way around is possible that means in such a way that the workpiece 2 is supported by the sliding table 17. The sliding table 17 can be driven on along the “X” in the circle 20 (rectangularly to the plane of drawing) and thus describes a possible machining axis. The sliding table 17 is also equipped with a cross slide 43 and thus allows a motion along the horizontal axis 21. The workpiece 2 is held over a clamping device 42. The tool spindles 3 can be driven only vertically along the double arrow 31, again two axes are given through the movement of the workpiece 2 itself, and the third axis is given through the spindle.

Additionally an angularly arranged sleeve 34 is provided which can put borings below angularly into the workpiece 2.

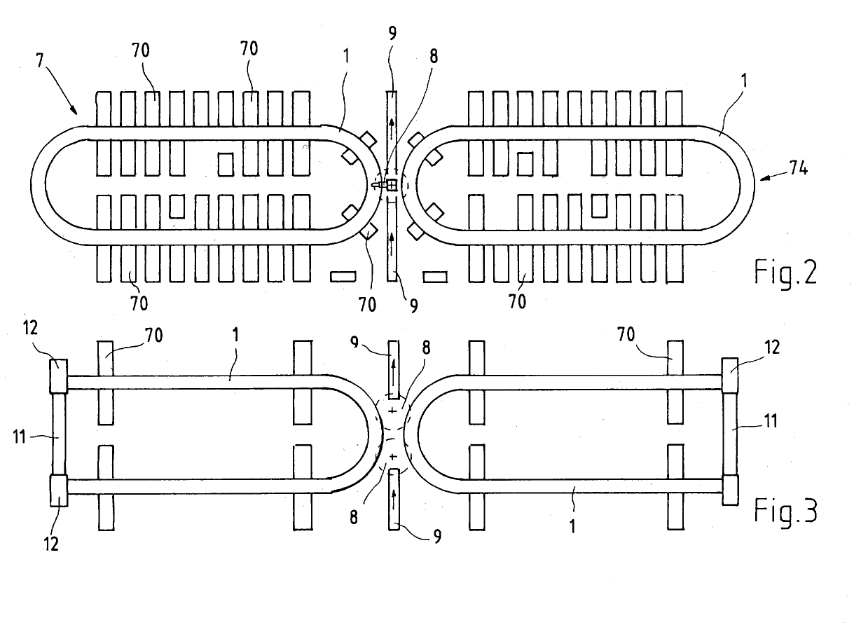

In FIGS. 2 and 3 a transfer installation is indicated which has a feed and a delivery belt 9 for the workpieces as well as one (FIG. 2) or two (FIG. 3) robots 8 which picks up the workpieces from the feed belt 9′, puts them into the transfer path 1 and there is moved through a machining installation according to the invention, in particular a transfer line 74 as described, for example, above.

FIG. 2 shows that the transfer line 74 is designed in the shape of a ring or has a closed U-shape. A car circulating on the transfer path 1 carries the workpiece to each respective machining station 70, respectively to the single spindles.

In FIG. 3 the transfer path is designed as a U the limbs of the U being connected via an elevated line 11. In order to reach the elevated line 11 elevators 12 are provided at the ends of the U. The construction with an elevated line 11 allows a better accessibility in particular in the inner space of the machining installation, for example for maintenance or checking purposes.

Two robots 8 are provided in this example for a higher loading, respectively unloading, speed of the transfer path 1.

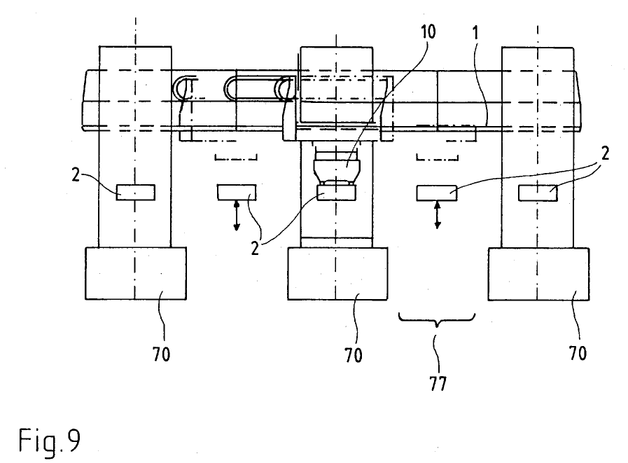

In FIG. 9 another variant according to the invention is shown. Partially three machining stations 70 of a machining installation (for example a flexible transfer line) are arranged one behind the other. These are connected by a transfer path 1. On the transfer path 1 a car 10 moves suspended which moves the workpiece 2 on the one hand along the transfer path 1 and on the other hand also in the respective machining station 70.

Now there is the possibility to provide the cars with energy for example via a busbar and thus design them circulating. However it is also possible to provide the cars with energy via a drag chain and arrange intermediate deposits 77 between the machining stations 70 where the workpieces are deposited. In this embodiment the car 10 would pick up the workpiece at a first intermediate deposit, convey it through the machining station 70 and deposit it again at the next intermediate deposit 77. The car of the next adjoining machining station then takes over further conveying of the workpiece. However, this variant also shows that the car 10 serves for conveying the workpiece between the machining stations in the machining installation as well as for conveying the workpiece within the machining station 70.

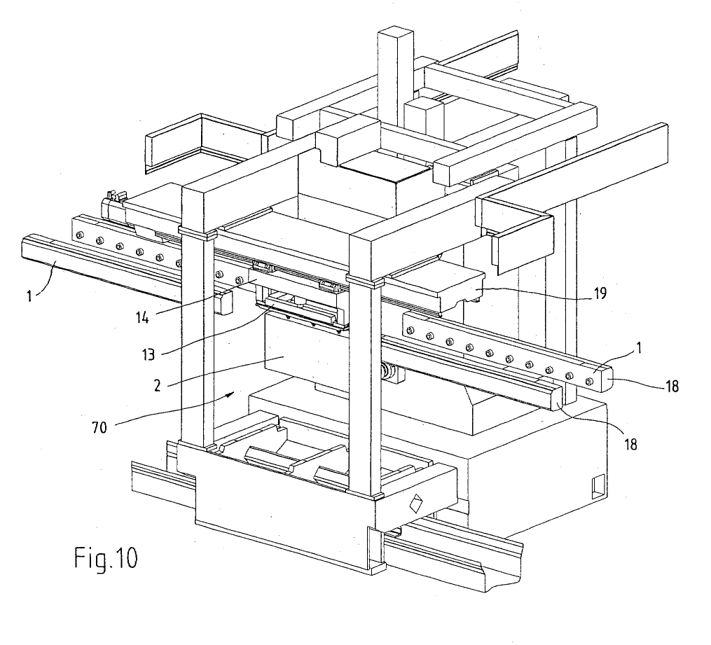

FIG. 10 shows another variant according to the invention. Here the workpiece 2 is conveyed by means of a first conveying unit 13 to the machining station 70. The transfer path 1 consists of a roller conveyor arranged above the conveying unit 13 taking over the workpiece 2 in a suspended manner, that means the workpiece is suspended below the conveying unit 13 and between the two sleepers 18 of the transfer path 1. The transfer path 1 may be designed, for example, as a friction roller conveyor. The transfer path 1 is not continues. In the area of the machining station 70 a second conveying unit 14 is provided which takes over conveying and positioning, respectively movement, of the workpiece 2 in the machining station 70. It has its own guide 19 which is essentially parallel to the direction of conveying on the transfer path 1. Both conveying units 13, 14 are optimised for each respective purpose. The outer transfer path does not need the high precision in positioning as the conveying unit 14.

Although the invention has been described in connection with special embodiments which are shown in a very specific way this has to be understood that this only serves for illustration and that the invention is not necessarily limited only to the examples shown here. The idea of the invention extends in every way to alternative designs or application techniques as the expert sees them as equivalently to this disclosure.

1. A machining installation comprising at least one transfer path feeding a workpiece to a plurality of machining stations, at least one tool spindle being provided in the machining station and the workpiece being situated in the machining station during a machining period and undergoing machining along at least one axis by at least one tool spindle possibly with cutting tools, characterised in that the workpiece (2) moves during at least part of the machining period.

2. Machining installation according to claim 1, characterised in that the tool acts on the workpiece (2) during the machining period, the workpiece (2) thus being moved.

3. Machining installation according to claim 1, characterised in that the machining station comprises at least two tool spindles and the workpiece (2) is moved from the first tool spindle to the second tool spindle during the machining period.

4. Machining installation according to claim 1, characterised in that a conveying means serves to convey the workpiece (2) between the machining stations and the conveying means also moves the workpiece (2) in the machining station.

5. Machining installation according to claim 1, characterised in that, in the case of multi-axis machining of the workpiece (2), the different machining axes are distributed between the directions of movement (30, 31) of the tool spindle (3) and the direction of movement (20, 21) of the workpiece (2).

6. Machining installation according to claim 1, characterised in that the direction of movement (20) of the workpiece (2) is parallel or approximately parallel to the direction of conveying of the workpiece (2).

7. Machining installation according to claim 1, characterised in that the workpiece (2) rotates and/or moves in a plane mounted on a compound slide (15, 41) and/or moves rectangularly to the direction of conveying.

8. Machining installation according to claim 1, characterised in that the workpiece (2) is held and/or machined from above, from below and/or laterally.

9. Machining installation according to claim 1, characterised in that the workpiece (2) is clamped on a car (10) serving as a conveying means movable on a transfer path (1) and is conveyed through the machining installation (7) thereon, the car (10) also moving in the machining station.

10. Machining installation according to claim 1, characterised in that a conveying unit (13) is provided on the transfer path (1) and comprises a positioning unit (4) for holding the workpiece (2), the positioning unit (4) and/or the conveying unit (13) moving during the machining of the workpiece (2).

11. Machining installation according to claim 9, characterised in that the car (10) comprises a positioning unit (4) for holding the workpiece (2).

12. Machining installation according to claim 10, characterised in that the positioning unit (4) is in the form of a slide, cross slide (43), compound slide (41) and/or circular table (40).

13. Machining installation according to claim 10, characterised in that the conveying unit (13) conveys the workpiece (2) through the machining installation (7) and/or the conveying unit (13) moves the workpiece (2) in the machining station (70).

14. Machining installation according to claim 10, characterised in that a first conveying unit (13) is provided to convey the workpiece (2) through the machining installation (7) and a transfer unit (16) in the machining station (70) transfers the workpiece (2) from the first conveying unit (13) to a second conveying unit (14) and, after machining, back again.

15. Machining installation according to claim 9, characterised in that the car (10) is in the form of a sliding table (17).

16. Machining installation according to claim 10, characterised in that the conveying unit (13) is in the form of a sliding table (17).

17. Machining installation according to claim 9, characterised in that the car comprises a clamping device (40) for the workpiece (2).

18. Machining installation according to claim 10, characterised in that the conveying unit comprises a clamping device (40) for the workpiece (2).

19. Machining installation according to claim 1, characterised in that the transfer path (1) is in the form of an overhead conveyor or a rail track.

20. Machining installation according to claim 14, characterised in that the first conveying unit (13) comprises a gripper serving as the transfer unit (16) which holds the workpiece (2) and transfers it to the second conveying unit.

21. Machining installation according to claim 14, characterised in that the second conveying unit (14) has a portal construction.

22. Machining installation according to claim 1, characterised in that the machining installation (7) is in the form of a transfer line (74) comprising a plurality of machining stations (70) arranged one behind the other or a sliding-table machine.

23. Transfer installation consisting of a feed belt (9′) and a delivery belt (9) for the workpieces (2) and a robot (8) which picks up the workpieces (2) from the feed belt (9′) and transfers them to a transfer path (1) of a machining installation (7) according to claim 1, in particular a closed-ring transfer line (75), the robot (8) transferring the workpiece (2) from the transfer path (1) to the delivery belt (9) after machining.
